(19) United States
(12) Patent Application Publication
(10) Pub. No.: US 2026/0097522 A1
(43) Pub. Date: Apr. 9, 2026

(54) SYSTEM FOR HANDLING ELECTRICAL COMPONENTS

(71) Applicant: Ford Global Technologies, LLC, Dearborn, MI (US)

(72) Inventors: Zachary James Kadykowski, Chelsea, MI (US); Kurt Michael Lundeen, Novi, MI (US); Juatia Sheree Samuel, Detroit, MI (US); Monica Velez, Saint Clair Shores, MI (US); Andrei Negrus, Prospect, KY (US); Derrick Miller, Ypsilanti, MI (US); Jon Arthur Zimmerman, Ferndale, MI (US)

(73) Assignee: Ford Global Technologies, LLC, Dearborn, MI (US)

(21) Appl. No.: 18/909,193

(22) Filed: Oct. 8, 2024

(51) Int. Cl. B25J 15/00; B25J 9/16; B25J 11/00

(52) U.S. Cl. CPC B25J 15/0033; B25J 9/1664; B25J 11/005

(57) ABSTRACT

A system that includes a workpiece and a robotic gripper apparatus. The workpiece includes a pair of opposed first retention features. Each first retention feature includes a first proximal end, a first distal end, and an outer periphery. The pair of opposed grippers are moveable between a first position in which the pair of opposed grippers engage the pair of opposed first retention features. Each gripper includes a mounting feature having a second proximal end, a second distal end, and an inner periphery. When the pair of opposed grippers are in the first position, a first portion of the inner periphery near the first proximal end engages a first portion of the outer periphery near the second proximal end and a second portion of the inner periphery near the first distal end is separated from a second portion of the outer periphery near the second distal end.

### FIELD

The present disclosure relates to a system for handling electrical components of a vehicle.

### BACKGROUND

The statements in this section merely provide background information related to the present disclosure and may not constitute prior art.

Industrial robots have been used for a variety of manufacturing operations, including by way of example, welding and moving parts from one location to another such as retrieving parts from a storage location and moving them to an assembly station. Automating the moving of some vehicle parts such as wire harnesses, for example, may be challenging because of the lack of proper handling of the part and mechanical repeatability.

These issues related to automating the handling of components, among other issues related to processing the components, are addressed by the present disclosure.

### SUMMARY

This section provides a general summary of the disclosure and is not a comprehensive disclosure of its full scope or all of its features.

In one form, a system for handling electrical components of a vehicle is provided. The system includes a workpiece and a robotic gripper apparatus. The workpiece is configured to include a set of the electrical components. The workpiece includes a pair of opposed first retention features. Each first retention feature of the pair of opposed first retention features includes a first proximal end, a first distal end, and an outer periphery tapered from the first proximal end towards the first distal end. The robotic gripper apparatus includes a pair of opposed grippers moveable between a first position in which the pair of opposed grippers engage the pair of opposed first retention features and a second position in which the pair of opposed grippers are disengaged from the pair of opposed first retention features. Each gripper includes a mounting feature having a second proximal end, a second distal end, and an inner periphery. The second proximal end opens through an inner side of the gripper. The inner periphery is tapered from the second proximal end towards the second distal end. When the pair of opposed grippers are in the first position, a first portion of the inner periphery near or at the first proximal end engages a first portion of the outer periphery near or at the second proximal end and a second portion of the inner periphery near or at the first distal end is separated from a second portion of the outer periphery near or at the second distal end.

In variations of the system of the above paragraph, which can be implemented individually or in any combination: the outer periphery of each first retention includes a pair of opposed surfaces extending at a first angle relative to each other; the inner periphery of each mounting feature includes a pair of opposed surfaces extending at a second angle relative to each other, the first angle different from the second angle; the first angle is greater than the second angle; the mounting feature of each gripper is an aperture extending through the gripper; when the pair of opposed grippers are in the first position, the second portion of the inner periphery of each mounting feature extends through the mounting feature; each first retention feature of the pair of opposed first retention features has a pyramid shape; the workpiece further includes a body configured to house the set of electrical components, the pair of opposed first retention features are spaced apart from the body; the workpiece further includes a pair of opposed second retention features; the system further includes a body configured to house the set of electrical components, the body including a retention socket defining a cavity and an opening in communication with the cavity; the workpiece further includes a second retention feature including a neck region and a tab extending from the neck region; the tab has a polygonal shape; a controller configured to move the pair of grippers between the first position and the second position; when the pair of grippers are in the first position, the controller is configured to instruct the robotic gripper apparatus to move the workpiece between a locked position in which the tab is received in the cavity and the neck region is received in the opening, and an unlocked position in which the tab is removed from the cavity and the neck region is removed from the opening; and the tab includes a pair of opposed flat sides that engage with and correspond to a pair of opposed sides defining the cavity to inhibit rotation of the workpiece when in the locked position.

In another form, a system for handling electrical components of a vehicle is provided. The system includes a workpiece, a robotic gripper apparatus, and a controller. The workpiece is configured to include a set of the electrical components. The workpiece includes a pair of opposed first retention features. Each first retention feature of the pair of opposed first retention features includes a first proximal end, a first distal end, and an outer periphery tapered from the first proximal end towards the first distal end. The outer periphery includes a pair of opposed surfaces extending at a first angle relative to each other. The robotic gripper apparatus includes a pair of opposed grippers moveable between a first position in which the pair of opposed grippers engage the pair of opposed first retention features and a second position in which the pair of opposed grippers are disengaged from the pair of opposed first retention features. Each gripper includes a mounting feature having a second proximal end, a second distal end, and an inner periphery. The second proximal end opens through an inner side of the gripper. The inner periphery is tapered from the second proximal end towards the second distal end and includes a pair of opposed surfaces extending at a second angle relative to each other. The second angle different from the first angle. The controller is configured to move the pair of grippers between the first position and the second position. When the pair of opposed grippers are in the first position, a first portion of the inner periphery near or at the first proximal end engages a first portion of the outer periphery near or at the second proximal end and a second portion of the inner periphery near or at the first distal end is separated from a second portion of the outer periphery near or at the second distal end.

In variations of the system of the above paragraph, which can be implemented individually or in any combination: the first angle is greater than the second angle; each first retention feature of the pair of opposed first retention features has a pyramid shape; the mounting feature of each gripper is an aperture extending through the gripper; the system further includes a body configured to house the set of electrical components, the body includes a retention socket defining a cavity and an opening in communication with the cavity; the workpiece further includes a second retention feature including a neck region and a tab extending from the neck region; when the pair of grippers are in the first position, the controller is configured to instruct the robotic gripper apparatus to move the workpiece between a locked position in which the tab is received in the cavity and the neck region is received in the opening, and an unlocked position in which the tab is removed from the cavity and the neck region is removed from the opening; and the tab includes a pair of opposed flat sides that engage with and correspond to a pair of opposed sides defining the cavity to inhibit rotation of the workpiece when in the locked position.

In yet another form, a system for handling electrical components of a vehicle is provided. The system includes a wire harness body, a workpiece, a robotic gripper apparatus, and a controller. The wire harness body is configured to house a first set of electrical components and includes a pair of opposed first protrusions and a retention socket. Each first protrusion of the pair of opposed first protrusions includes a first proximal end, a first distal end, and a first outer periphery tapered from the first proximal end towards the first distal end. The retention socket defines a cavity and an opening in communication with the cavity. The workpiece is configured to include a second set of the electrical components and includes a pair of opposed second protrusions and a retention feature. Each second protrusion of the pair of opposed second protrusions includes a second proximal end, a second distal end, and a second outer periphery tapered from the second proximal end towards the second distal end. The retention feature includes a neck region and a tab extending from the neck region. The robotic gripper apparatus includes a pair of opposed grippers moveable between a first position in which the pair of opposed grippers engage the pair of opposed first protrusions of the wire harness body and a second position in which the pair of opposed grippers engage the pair of opposed second protrusions of the workpiece. Each gripper includes a mounting feature having a third proximal end, a third distal end, and an inner periphery. The third proximal end opens through an inner side of the gripper. The inner periphery is tapered from the third proximal end towards the third distal end. The controller is configured to move the pair of grippers between the first position and the second position. When the pair of opposed grippers are in the first position, a first portion of the inner periphery near or at the third proximal end engages a first portion of the first outer periphery near or at the first proximal end and a second portion of the inner periphery near or at the third distal end is separated from a second portion of the first outer periphery near or at the first distal end. When the pair of opposed grippers are in the second position, the first portion of the inner periphery near or at the third proximal end engages a first portion of the second outer periphery near or at the second proximal end and the second portion of the inner periphery near or at the third distal end is separated from a second portion of the second outer periphery near or at the second distal end. When the pair of grippers are in the second position, the controller is configured to instruct the robotic gripper apparatus to move the workpiece between a locked position in which the tab is received in the cavity and the neck region is received in the opening, and an unlocked position in which the tab is removed from the cavity and the neck region is removed from the opening.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a perspective view of a system for handling components of a vehicle according to the principles of the present disclosure with a wire harness component of the components being disposed on a work surface;

FIG. 2A is a perspective view of one collar of a plurality of collars of the system of FIG. 1;

FIG. 2B is a perspective view of a workpiece of the collar shown in FIG. 2A;

FIG. 2C is a top view of the workpiece of the collar shown in FIG. 2A;

FIG. 2D is a perspective view of alternate workpiece that can be incorporated into the collar of FIG. 2A;

FIG. 3A is a perspective view of another collar of a plurality of collars of the system of FIG. 1;

FIG. 3B is a top view of the collar shown in FIG. 3A;

FIG. 4 is a perspective view of another collar of a plurality of collars of the system of FIG. 1;

FIG. 5 is a perspective view of one electrical connector of a plurality of electrical connectors of the system of FIG. 1;

FIG. 6A is a perspective view of a robotic gripper apparatus of a robot shown in the system of FIG. 1;

FIG. 6B is a perspective view of one gripper of the robotic gripper apparatus of FIG. 6A;

FIG. 6C is a top view of the gripper shown in FIG. 6B;

FIG. 7 is a top view of another gripper that can be incorporated into the robotic gripper apparatus;

FIG. 8 is a cross-sectional view of the robotic gripper apparatus grasping the collar shown in FIG. 2A;

FIG. 9A - 9C are schematic views showing the robot of the system of FIG. 1 unfolding a vehicle component of the system shown in FIG. 1;

FIGS. 10A-10C are schematic views showing the robot of the system of FIG. 1 connecting electrical connectors to a vehicle module;

FIG. 11 is a schematic block diagram showing components of the system of FIG. 1 in accordance with the teachings of the present disclosure; and

FIG. 12 is a flowchart depicting an algorithm for handling components of the system of FIG. 1 in accordance with the teachings of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

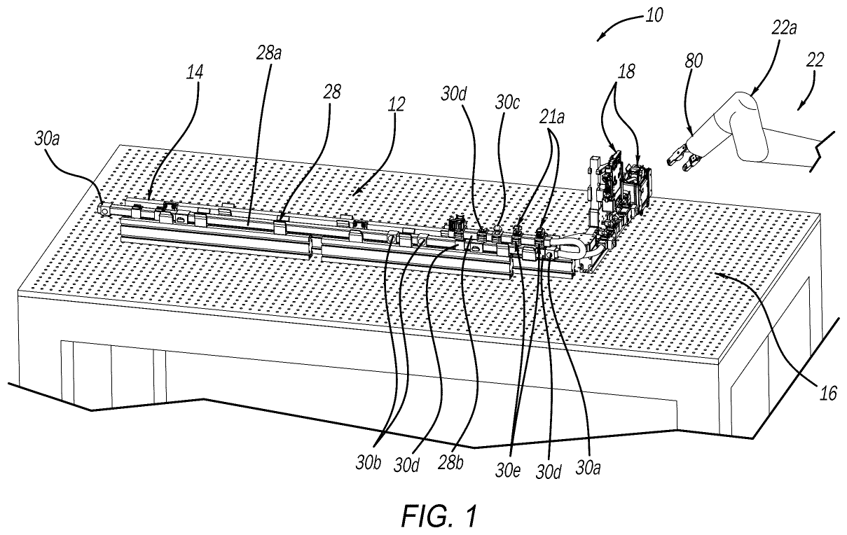

With reference to FIG. 1A, a system 10 for handling one or more vehicle components 12 is illustrated. The handling of the vehicle components 12 may include retrieving the vehicle components 12 from a part support (e.g., a dunnage rack), placing the vehicle components 12 onto a work surface 16, manipulating parts of the vehicle components 12 on the work surface 16, coupling electrical components 21 of the vehicle components 12 to vehicle modules 18 on the work surface 16 and/or installing the vehicle components 12 into a machine (e.g., a vehicle). The system 10 allows for the handling of the vehicle components 12 with little to no human intervention. In this way, the handling of the vehicle components 12 may be automated to increase productivity, reduce cycle time, and reduce variation and error, for example. In the example illustrated, the vehicle components 12 include the electrical components 21 such as wire harnesses. The system 10 of the present disclosure provides for the adaptation of vehicle components 12 to better support automation.

The system 10 may include the vehicle components 12 (only one shown in the figures), a fixture 14, one or more robots 22 and a controller 26. Each vehicle component 12 may be moved to the fixture 14 from the part support (not shown). One example of a system for moving the vehicle component 12 from the part support to the fixture 14 is disclosed in U.S. Patent App. No. XX/000,000, and titled “SYSTEM FOR HANDLING A COMPONENT OF A VEHICLE” which is commonly owned with the present application and the contents of which are incorporated herein by reference in its entirety. Each vehicle component 12 includes a body or housing 28 and a plurality of collars 30a, 30b, 30c, 30d, 30e. The body 28 may be made of a rigid material (e.g., metal or plastic) and may house electrical components 21 (e.g., flexible wires). In the example illustrated, the body 28 is hollow and has a square shape. In some forms, the body 28 may have a circular shape, rectangular shape, or any other suitable shape that may be house electrical components.

In the example illustrated, the body 28 includes multiple sections 28a, 28b that are movable relative to each other. For example, the sections 28a, 28b may be coupled to each other (e.g., folding onto each other) as the vehicle component 12 moves from the part support (not shown) to the fixture 14. In this way, moving the vehicle component 12 to the fixture 14 is facilitated. Once the vehicle component 12 is coupled to the fixture 14, the sections 28a, 28b of the vehicle component 12 may be decoupled from each other (e.g., unfolded from each other) using the robot 22 and positioned at predetermined positions with respect to each other for further processing. In the example illustrated, the section 28b of the vehicle component 12 is decoupled or detached from the section 28a and positioned with respect to the section 28a once the vehicle component 12 is coupled to the fixture 14.

In the example illustrated, the sections 28a, 28b may be spaced apart from each other once the vehicle component 12 is coupled to the fixture 14. The electrical components 21 (e.g., wires) may extend through the sections 28a, 28b of the body 28 and may have ends that are secured to the body 28. It should be understood that although the present disclosure discloses the body 28 having two sections 28a, 28b movable relative to each other, the body 28 may include more than two sections movable relative to each other without departing from the scope of the present disclosure.

The collars 30a may be coupled at opposing ends of the section 28a of the vehicle component 12 and may be configured to attach the vehicle component 12 to the part support (not shown). One example of such collar is disclosed in U.S. Patent App. No. XX/000,000, and titled “SYSTEM FOR HANDLING A COMPONENT OF A VEHICLE” which is commonly owned with the present application and the contents of which are incorporated herein by reference in its entirety. The collars 30b may be coupled to the section 28a of the vehicle component 12 between the collars 30a and may be configured to allow a robot (not shown) to grasp the vehicle component 12 for moving from the part support to the fixture 14. One example of such collar is disclosed in U.S. Patent App. No. XX/000,000, and titled “SYSTEM FOR HANDLING A COMPONENT OF A VEHICLE” which is commonly owned with the present application and the contents of which are incorporated herein by reference in its entirety.

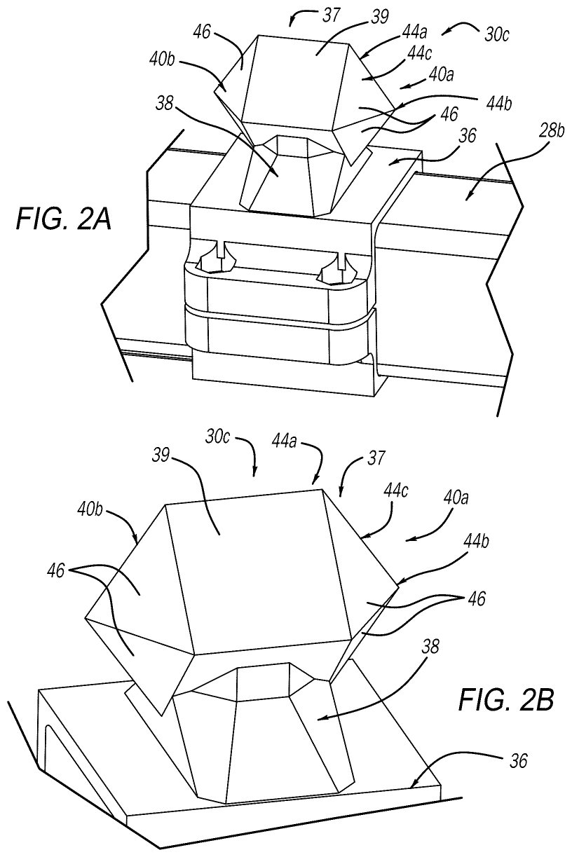

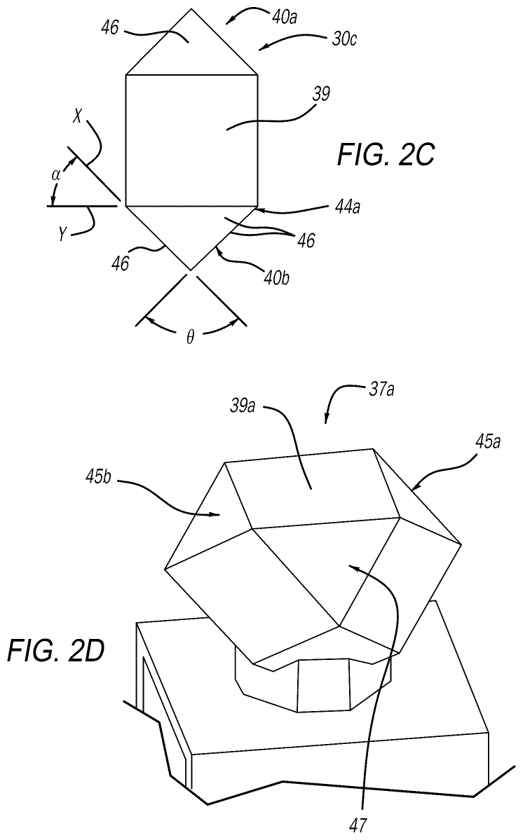

With reference to FIGS. 1, 2A, 2B, and 2D, each collar 30c may be coupled to the section 28b of the vehicle component 12 and may be configured to attach to the robot 22 such that the robot 22 may grasp the section 28b of the vehicle component 12 and move the section 28b relative to the section 28a of the vehicle component 12 (i.e., move the section 28b to another location of the fixture 14). The collar 30c includes a body 36 and workpiece 37. The body 36 surrounds the section 28b of the body 28 and is secured to the section 28b via mechanical fasteners, adhesives, or any other suitable attachment means. The body 36 has a shape that corresponds to the shape of the body 28. In the example illustrated, the body 36 has a square shape that corresponds to the square shape of the body 28. The body 36 also has end portions defining apertures. Mechanical fasteners may extend through the apertures of the end portions, thereby securing (e.g., clamping) the body 36 onto the body 28.

The workpiece 37 is spaced apart from the body 36 via a connecting member 38 such that the robot 22 may grasp the workpiece 37 of the vehicle component 12 and move the section 28b relative to the section 28a of the vehicle component 12. Stated differently, the connecting member 38 having a predetermined shape provides a predetermined distance between the body 36 and the workpiece 37 to allow for the robot 22 to grasp the workpiece 37 without contacting the body 36. The workpiece 37 includes a connecting structure 39 and a pair of opposed retention features 40a, 40b. The connecting structure 39 extends from the connecting member 38 and includes a shape or profile that may be different from the shape of the connecting member 38. For example, the connecting structure 39 may have a generally cuboid shape. The cuboid shaped connecting structure 39 may have a length that extends parallel to the section 28b of the body 28 while the connecting member 38 may have a length that extends perpendicular to the section 28b of the body 28.

Each retention feature 40a, 40b of the pair of opposed retention features 40a, 40b extends outward from a respective end of the connecting structure 39 and is configured to mate with a respective mounting feature 42 of the robot 22 as will be described in more detail below. In the example illustrated, the retention feature 40a, 40b is a protrusion or projection extending outward from the respective end of the connecting structure 39. Each retention feature 40a, 40b has a pyramid shape and includes a proximal end 44a, a distal end 44b, and an outer periphery 44c. The proximal end 44a extends from the connecting structure 39 and the distal end 44b has a pointed end. The outer periphery 44c is tapered from the proximal end 44a toward the distal end 44b. In the example illustrated, the outer periphery 44c includes a plurality of angled surfaces 46 extending from the connecting structure 30 toward the distal end 44b. Each surface 46 may have a triangular profile. A line X extending along a respective surface 46 may form an angle α with a line Y extending along the proximal end 44a of the retention feature 40a, 40b in a direction perpendicular to a longitudinal axis of the section 28b of the body 28. In some forms, the angle α may be approximately 45 degrees. In other forms, the angle α may be less than or greater than 45 degrees. Two opposed surfaces 46 of the plurality of angled surfaces 46 may form an angle θ with respect to each other. In the example illustrated, the angle θ may be approximately 90 degrees. In other forms, the angle θ may be greater than or less than 90 degrees.

Although the present disclosure shows the workpiece 37 as being separate from the body 28, in some forms, the body 28 may be manufactured (e.g., injection molding or 3D printing) to include the workpiece 37. In this way, the body 28 may be a unitary, monolithic component including the workpiece 37 for connecting to the robot 22.

In some forms, as shown in FIG. 2D, another workpiece 37a is provided that may include a connecting structure 39a, a first pair of opposed retention features 45a, 45b and a second pair of opposed retention features 47 (only one shown in the figures). The structure and function of the first pair of opposed retention features 45a, 45b and the second pair of opposed retention features 47 may be similar or identical to the pair of opposed retention features 40a, 40b described above, and therefore, will not be described again in detail. The workpiece 37a including multiple opposed retention features 45a, 45b, 47 provide multiple mounting locations for the robot 22. In other forms, another workpiece (not shown) may be provided that includes a connecting structure (not shown), one retention feature (not shown) extending from a first end of the connecting structure, and a flat or arcuate surface at an opposing second end of the retention feature. In this way, a robot may move the vehicle component by grasping the retention feature of the workpiece.

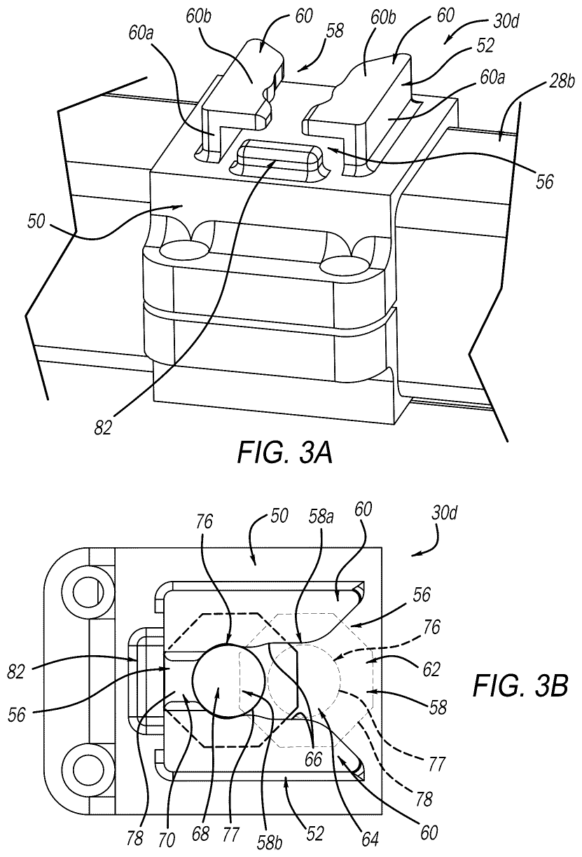

With reference to FIGS. 1, 3A, and 3B, the collars 30d may be coupled to one of the sections 28a, 28b of the body 28 and may be configured to secure the other of the sections 28a, 28b of the body 28 relative to the one of the sections 28a, 28b. Each collar 30d includes a body 50 and a retention socket 52. In the example illustrated, the body 50 surrounds the body 28 of the vehicle component 12 and is secured to the body 28 via mechanical fasteners. The body 50 has a shape that corresponds to the shape of the body 28. In the example illustrated, the body 50 has a square shape that corresponds to the square shape of the body 28. The body 50 also has end portions defining apertures. Mechanical fasteners may extend through the apertures of the end portions, thereby securing (e.g., clamping) the body 50 onto the body 28.

The retention socket 52 extends from the body 50 and is configured to receive a retention feature 76 of the collar 30e (or retention feature 85b of the electrical connector 21a) as will be described in more detail below. The retention socket 52 defines an internal cavity 56 and an opening 58 in communication with the internal cavity 56. Stated differently, the retention socket 52 includes a pair of walls or brackets 60 that extend from the body 50 and cooperate with each other to define the internal cavity 56 and the opening 58. In the example illustrated, each wall 60 has an L-shape and is resiliently flexible. Each wall 60 also has a first end 60a extending from the body 50 and a second end 60b spaced apart from the body 50. The opening 58 opens through to a side of the retention socket 52 and defines a first portion 58a and a second portion 58b. When the retention feature 76 of the collar 30e is received in the first portion 58a of the opening 58, the retention feature 76 (and the collar 30e) may move relative to the body 50. When the retention feature 76 is received in the second portion 58b of the opening 58, the retention feature 76 (and the collar 30e) are inhibited from moving relative to the body 50.

The first portion 58a of the opening 58 includes an insertion region 62 and an alignment region 64. The insertion region 62 has a width that narrows toward to the alignment region 64. In this way, the retention socket 52 may accommodate for alignment error between the retention feature 76 and the alignment region 64. The alignment region 64 is located between the insertion region 62 and the second portion 58b of the opening 58 and may align the retention feature 76 received therein as it moves from the insertion region 62 toward the second portion 58b of the opening 58. A pair of opposed tabs 66 may extend from respective walls 60 into the opening 58. Stated differently, the pair of tabs 66 may extend from the respective walls 60 into the opening 58 and may define a transition region that is between the alignment region 64 and the second portion 58b of the opening 58. A width of the transition region may be less than a width of the alignment region 64. In this way, a predetermined force has to be applied to the retention feature 76 when the retention feature 76 is at the tabs 66 to overcome the biasing force of the walls 60 and move the retention feature 76 of the collar 30e between the first and second portions 58a, 58b of the opening 58.

The second portion 58b of the opening 58 includes a locking region 68 and an end region 70. In the example illustrated, the locking region 68 has a width that is greater than or equal to the width of the alignment region 64. The locking region 68 is located between the end region 70 and the alignment region 64. When the retention feature 76 of the collar 30e is received in the locking region 68, the retention feature 76 is inhibited from moving relative to the body 50 unless a predetermined force is applied to the retention feature 76 in a predetermined direction. The end region 70 has a width that is less than the width of the locking region 68 and less than the width of the transition region. Although the present disclosure shows the retention socket 52 as being separate from the body 28, in some forms, the body 28 may be manufactured (e.g., injection molding or 3D printing) to include the retention socket 52. In this way, the body 28 may be a unitary, monolithic component including the retention socket 52 for connecting to the retaining feature 76.

In the example illustrated, the collars 30e may be coupled to the body 28 (e.g., the section 28b of the body 28 or the section 28a of the body 28) of the vehicle component 12 and may be configured to perform multiple functions. For example, the collars 30e may secure electrical connectors 21a of the electrical components 21 to the body 28 and may be configured to secure one of the sections 28a, 28b of the body 28 relative to the other of the sections 28a, 28b of the body 28. Each collar 30e includes a body 72, a retention socket 74, and the retention feature 76. In the example illustrated, the body 72 surrounds the section 28b of the body 28 of the vehicle component 12 and is secured to the section 28b of the body 28 via mechanical fasteners. The body 72 has a shape that corresponds to the shape of the body 28. In the example illustrated, the body 72 has a square shape that corresponds to the square shape of the body 28. The body 72 also has end portions defining apertures. Mechanical fasteners may extend through the apertures of the end portions, thereby securing (e.g., clamping) the body 72 onto the body 28.

The retention socket 74 extends from a side of the body 72 and is configured to receive a retention feature 85b of a respective electrical connector 21a as will be described in more detail below. The structure and function of the retention socket 74 may be similar or identical to the retention socket 52 described above, and therefore, will not be described again in detail.

The retention feature 76 extends from a side of the body 72 that is opposite the side and is configured to be received in the opening 58 of the collar 30d. That is, the retention feature 76 may be movable within the opening 58 of the collar 30d between a first position in which the retention feature 76 is received in the first portion 58a of the opening 58 of the retention socket 52 (shown in FIG. 3B in phantom lines) and a second position in which the retention feature 76 is received in the second portion 58b of the opening 58 of the retention socket 52 (shown in FIG. 3B in solid lines). When the retention feature 76 is in the first position, the retention feature 76 (and the section 28b of the body 28) is allowed to move relative to the section 28a of the body 28, and when the retention feature 76 is in the second position, the retention feature 76 (and the section 28b of the body 28) is inhibited from moving relative to the section 28a of the body 28.

The retention feature 76 includes a neck region 77 and a tab 78. In the example illustrated, the neck region 77 has a generally cylindrical shape and extends between the tab 78 and the side of the body 72. The neck region 77 is also configured to be received in the opening 58 of the retention socket 52 of the collar 30d. That is, when the neck region 77 is received in the first portion 58a of the opening 58, the collar 30e (and the section 28b) is allowed to move relative to the section 28a of the body 28 (shown phantom lines in FIG. 3B). When the neck region 77 is received in the locking region 68 of the opening 58, the collar 30e (and the section 28b of the body 28) is inhibited from moving relative to the section 28a of the body 28 (shown in solid lines in FIG. 3B). The neck region 77 has a diameter that is equal to or less than the width the alignment region 64 and the width of the locking region 68. The diameter of the neck region 77 is greater than the width of the transition region 67 defined by the tabs 66. When a predetermined force is applied to the retention feature 76, the retention feature 76 pushes on the tabs 66, which, in turn, causes the pair of walls 60 to move away from each other. In this way, the neck region 77 of the retention feature 76 may move into the locking region 68 where it is inhibited from moving relative to the collar 30d (and the section 28a of the body 28). In some forms, the neck region 77 may have a different shape (e.g., polygonal) as long as the width is equal to or less than the width of the alignment region 64 and the width of the locking region 68, and greater than the width of the transition region 67.

In the example illustrated, the tab 78 is configured to be received in the internal cavity 56 of the retention socket 52 and has a polygonal shape. Stated differently, the tab 78 has an octagonal shape with a plurality of flat sides 79. In this way, the retention feature 76 has multiple insertion orientations into the internal cavity 56 (i.e., the tab 78 can be inserted into the internal cavity 56 every 45 degrees). In some forms, the tab 78 may have a square shape or any other suitable shape that gives the tab 78 multiple insertion orientations into the internal cavity 56. Once the tab 78 is inserted into the internal cavity 56, two flat sides 79 of the tab 78 correspond to two inner sides of the retention socket 52, thereby inhibiting the retention feature 76 from rotating within the retention socket 52. The tab 78 may abut against a stop member 82 of the collar 30d, thereby inhibiting movement of the retention feature 76 towards the end region 70. It should be understood that, in some configurations, collars (not shown) may be provided on the body 28 that include one or more retention features 76 without the retention socket 52. Although the present disclosure shows the retention socket 74 and the retention feature 76 as being separate from the body 28, in some forms, the body 28 may be manufactured (e.g., injection molding or 3D printing) to include the retention socket 74 and the retention feature 76. In this way, the body 28 may be a unitary, monolithic component including the retention socket 74 and the retention feature 76.

The fixture 14 is removably coupled to the work surface 16 such that the fixture 14 may be graspable by a robot (not shown). That is, the fixture 14 may be supported on one or more rails or beams that may be secured to the work surface 16 such that the fixture 14 is spaced apart from the work surface 16, thereby allowing the robot to grasp the fixture 14 and remove it from the work surface 16. One example of such fixture is disclosed in U.S. Patent App. No. XX/000,000, and titled “METHOD AND SYSTEM FOR INSTALLING WIRING HARNESS INTO VEHICLE,” which is commonly owned with the present application and the contents of which are incorporated herein by reference in its entirety.

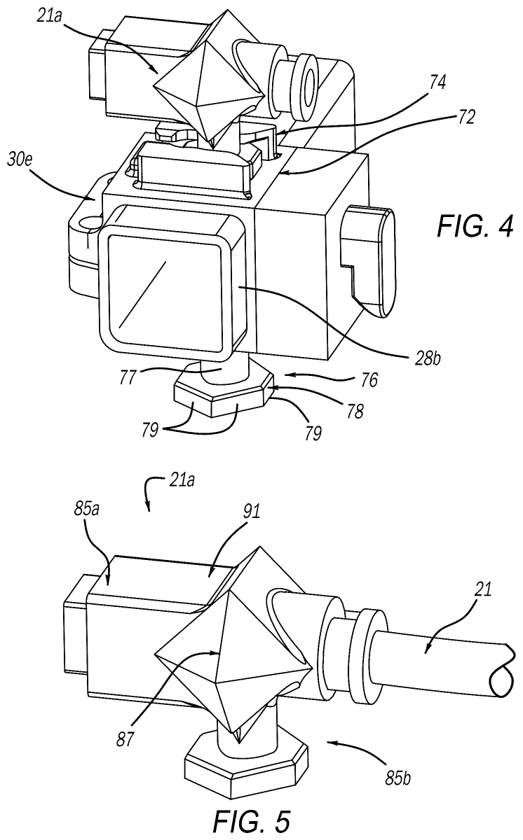

The electrical connectors 21a may be removably coupled to the collars 30d (and the body 28) and may be configured to connect to the vehicle modules 18, thereby transmitting electric power and information to the vehicle modules 18. The electrical connectors 21a may be removed from the collars 30d at the work surface 16 and connected to the vehicle modules 18 using the robot 22 as will be described in more detail below. Each electrical connector 21a may include a body 85a, a first retention feature 85b and second retention features 87 (only one shown in FIGS. 4 and 5). The first retention feature 85b extends from the body 85a and is configured to be removably coupled to the retention socket 74 of the collar 30e. The structure and function of the first retention feature 85b may be similar or identical to the retention feature 76 described above, and therefore, will not be described again in detail. The second retention features 87 extend from opposing sides of the body 85a and are configured to be grasp by the robot 22 such that the robot 22 may move the electrical connector 21a from the collar 30d and connect the electrical connector 21a to the vehicle module 18. The structure and function of the second retention features 87 may be similar or identical to the retention features 40a, 40b, respectively, described above, and therefore, will not be described again in detail.

In the example illustrated, the electrical connector 21a comprises a separate sleeve 91 that includes the body 85a, the first retention feature 85b and the second retention features 87. The sleeve 91 connects to an existing electrical connector (e.g., sleeved on the electrical connector), thereby forming the electrical connector 21a that functions as described above. In some forms, the electrical connector 21a comprises a separate dress cover that includes the body 85a, the first retention feature 85b and the second retention features 87a, 87b. The dress cover connects to the existing electrical connector, thereby forming the electrical connector 21a that functions as described above. In other forms, the electrical connector 21a comprises a separate component that includes the body 85a, the first retention feature 85b and the second retention features 87a, 87b. The component is clipped on to the existing electrical connector, thereby forming the electrical connector 21a that functions as described above. It should be understood that, in some configurations, the electrical connector 21a may be manufactured to include the body 85a, the first retention feature 85b and the second retention features 87a, 87b, thereby inhibiting having to couple a separate part to the existing electrical connector.

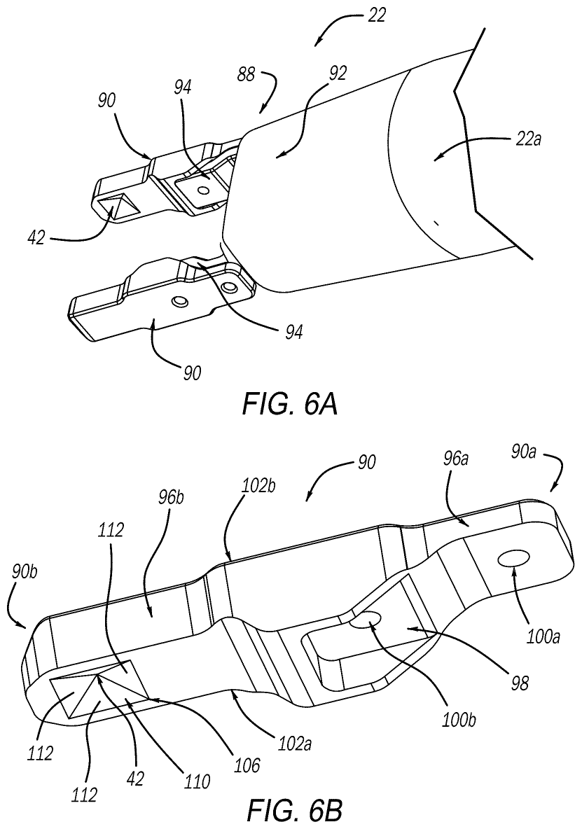

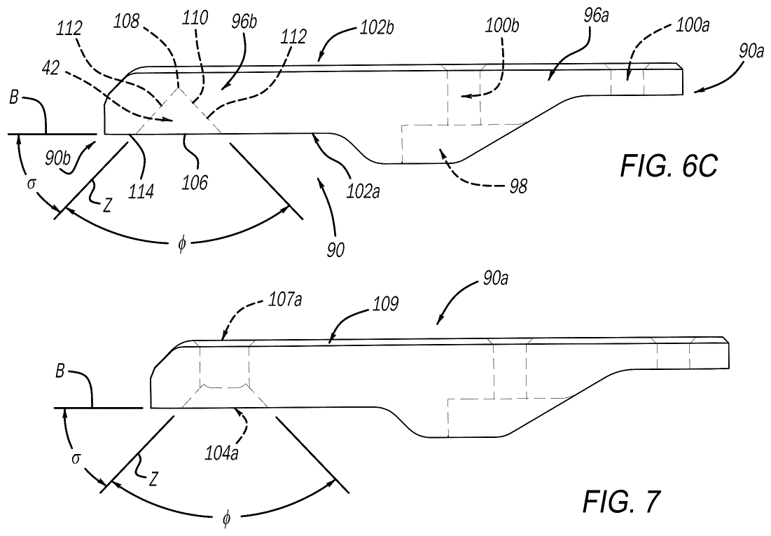

With reference to FIGS. 1 and 6A-6C, the robot 22 includes a robot arm 22a and a robotic gripper structure or apparatus 80. The robot arm 22a includes a plurality of segments connected to each other at joints, thereby allowing the robot 22 to have multiple degrees of freedom. The robot arm 22a is also secured to the work surface 16 at a first end. In some variations, the robot arm 22a includes an optional adapter (not shown) that is adapted to be secured to the work surface 16. In some forms, the robot 22 is separate from the work surface 16 and is partially or fully autonomous and is configured to autonomously move to the part support (not shown) and/or work surface 16 as instructed by the controller 26. To autonomously move itself, the controller 26 is configured to control various movement systems of the robot 22 based on location data obtained from one or more sensors. In an example application, the movement systems may include propulsion systems, steering systems for controlling wheels, and/or brake systems, and the sensors for providing location data may include a GNSS sensor, an imaging sensor, a local position sensor, among others.

The robotic gripper structure 80 is secured to the robot arm 22a and is configured to grasp and move one section 28a, 28b of the vehicle component 12 relative to the other section 28a, 28b of the vehicle component 12. The robotic gripper structure 80 is also configured to connect the electrical connectors 21a of the electrical components 21 to terminals 86 of the vehicle modules 18 as will be described in more detail below.

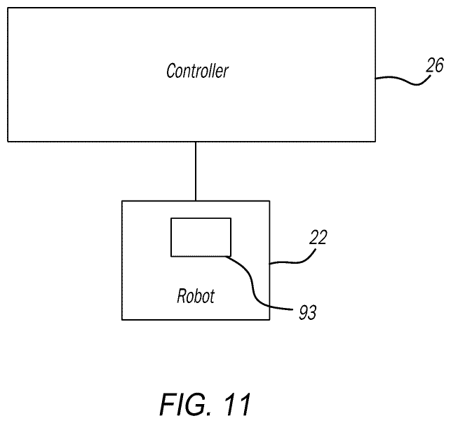

The robotic gripper structure 80 includes an actuator assembly 88 and a pair of opposed grippers 90. The actuator assembly 88 is secured to a second end of the robot arm 22a. The actuator assembly 88 includes a body 92, a motor 93 (FIG. 11), and a pair of movable members or arms 94. The body 92 is secured to the second end of the robot arm 22a. The motor 93 is associated with the body 92 (e.g., disposed within the body 92) and is in electrical communication with the controller 26. The controller 26 may be in communication with the motor 93 via, for example, an internet, Wi-Fi, Bluetooth®, Zigbee®, power-line carrier communication (PLCC), or cellular connection or any other wired or wireless communication protocol. The motor 93 is operable between an OFF mode and an ON mode. In one form, the motor 93 may be an electric motor such as a brushless drive motor. Each arm 94 is operatively connected to the motor 93 via a respective rail or connecting member (not shown) and is allowed to move in a transverse direction (i.e., transverse to a longitudinal direction of the arm 94). For example, when the motor 93 is in the OFF mode, the arms 94 are inhibited from moving in the transverse direction. When the motor 93 is in the ON mode, the arms 94 are allowed to move in the transverse direction between an open state and a closed state.

Each gripper 90 is secured to a respective arm 94 and is movable in a transverse direction between a first or closed position and a second or open position. Stated differently, each gripper 90 is secured to the respective arm 94 such that when the respective arm 94 is moved to the closed state, the gripper 90 is moved to the closed position, and when the respective arm 94 is in the open state, the gripper 90 is in the open position.

In the example illustrated, each gripper 90 includes a variable thickness from a first end 90a of the gripper toward a second end 90b of the gripper 90. The gripper 90 also includes an attachment portion 96a and an engaging portion 96b. The attachment portion 96a is located near or at the first end 90a of the gripper 90 and includes a recess 98 and a plurality of openings 100a, 100b. The recess 98 may be formed on an inner side 102a of the gripper 90 and may receive a portion of a respective arm 94. The openings 100a, 100b may be spaced apart from each other and may extend from an outer side 102b of the gripper 90 to the recess 98 formed on the inner side 102a of the gripper 90. In this way, mechanical fasteners (not shown) may extend through the respective arm 94 and the openings 100a, 100b, thereby securing the respective arm 94 and the gripper 90 to each other.

The engaging portion 96b is located near or at the second end 90b of the gripper 90 and includes a mounting feature 42 that is configured to engage with a respective retention feature 40a, 40b of the collar 30c or a respective retention feature 87 of the electrical connector 21a. In the example illustrated, the mounting feature 42 is an aperture formed in the engaging portion 96b of the gripper 90. The mounting feature 42 includes a proximal end 106, a distal end 108, and an inner periphery 110. The proximal end 106 opens through to the inner side 102a of the gripper 90 and the distal end 108 is located between the inner side 102a of the gripper 90 and the outer side 102b of the gripper 90 (i.e., the mounting feature 42 does not extend through the gripper 90).

The inner periphery 110 is tapered from the proximal end 106 toward the distal end 108. In the example illustrated, the inner periphery 110 includes a plurality of angled surfaces 112 extending from the proximal end 106 toward the distal end 108. Each surface 112 may have a triangular profile. A line Z extending along a respective surface 112 may form an angle σ with a line B extending along an inner surface 114 of the gripper 90. In some forms, the angle σ may be approximately 47 degrees. In other forms, the angle σ may be less than or greater than 47 degrees. Two opposed surfaces 112 of the plurality of angled surfaces 112 may form an angle φ with respect to each other. In the example illustrated, the angle φ may span approximately 86 degrees. In other forms, the angle φ may span greater than or less than 86 degrees.

The system 10 may further include vision sensors not shown. The vision sensors collect visual image data and transmits the data to the controller 26. In this way, aligning the pair of grippers 90 relative to the retention features 40a, 40b, 87 is facilitated. One example of such vision sensor is disclosed in U.S. Patent App. No. XX/000,000, and titled “METHOD AND SYSTEM FOR INSTALLING WIRING HARNESS INTO VEHICLE,” which is commonly owned with the present application and the contents of which are incorporated herein by reference in its entirety.

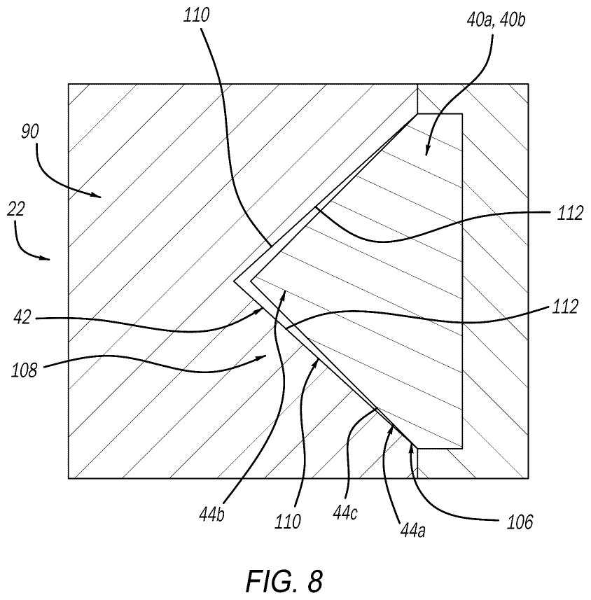

When the pair of opposed grippers 90 are in alignment with the workpiece 37, the pair of opposed grippers 90 may move from the open position to the closed position such that the pair of opposed grippers 90 engage the opposed retention features 40a, 40b of the workpiece 37. When the pair of opposed grippers 90 engage the opposed retention features 40a, 40b, a first portion of the inner periphery 110 near or at the proximal 106 of each gripper 90 engages a first portion of the outer periphery 44c near or at the proximal end 44a of each retention feature 40a, 40b and a second portion of the inner periphery 110 near or at the distal end 108 of each gripper 90 is separated from a second portion of the outer periphery 44c near or at the distal end 44b of each retention feature 40a, 40b. The geometry of the mounting features 42 of the grippers 90 and the retention features 40a, 40b of the workpiece 37 are configured to provide separation between mating interfaces (see FIG. 8), thereby proving a robust and stable interaction. Stated differently, the angle σ being less than the angle α and the angle θ being greater than the angle φ provides separation between the mating interfaces. The electrical components 21 may cause a force to pull on the electrical connectors 21a, thereby attempting to shift the workpiece 37 relative to the grippers 90. The separation between the mating interfaces provides the ability to counteract the force attempting to shift the workpiece 37 relative to the grippers 90.

When the pair of opposed grippers 90 are in alignment with the electrical connector 21a, the pair of grippers 90 may move from the open position to the closed position such that the pair of opposed grippers 90 engage the opposed retention features 87 in a similar manner as described above with respect to the opposed retention features 40a, 40b.

In some forms, as shown in FIG. 7, a gripper 90a may include a mounting feature 104a and a pass-through hole 107a. The pass-through hole 107a extends from the mounting feature 104a to the outer side 109 of the gripper 90a. In this way, the respective retention feature 40a, 40b, 87 may pass through gripper 90a such that the distal end 44b of the respective retainer feature 40a, 40b, 87 extends past the outer side 109 of the gripper 90a. The pass-through hole 107a further provides for separation with the mating interfaces.

With reference to FIG. 11, the controller 26 is in communication with the robot 22 and may monitor and control operations of the robot 22 based on data received. In one example, the controller 26 is in communication with the robot 22 using a wired or wireless communication protocol (e.g., a Bluetooth®-type protocol, a cellular protocol, a wireless fidelity (Wi-Fi)-type protocol, a near-field communication (NFC) protocol, an ultra-wideband (UWB) protocol, among others).

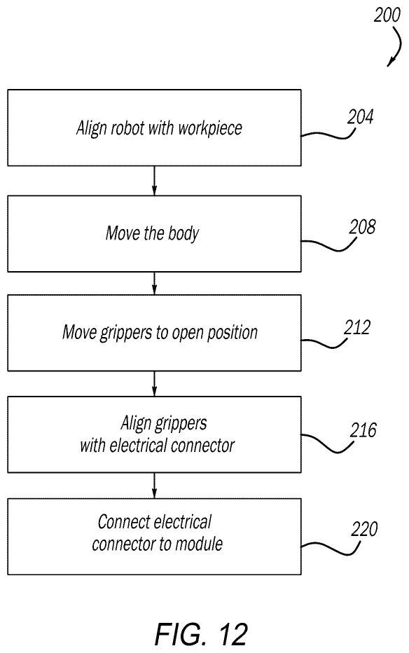

Referring to FIG. 12, an example control algorithm 200 for moving the sections 28a, 28b of the vehicle component 12 relative to each other and connecting the electrical connectors 21a to the vehicle modules 18 is illustrated. The processing may begin once the vehicle component 12 is moved from the part support (not shown) to the fixture 14. At 204, the control algorithm, using the controller 26, instructs the robot 22 to align with the retention features 40a, 40b of the workpiece 37 and move the pair of grippers 90 from the open position to the closed position. In this way, the mounting features 42 of the pair of grippers 90 engage the retention features 40a, 40b of the workpiece 37 as described above.

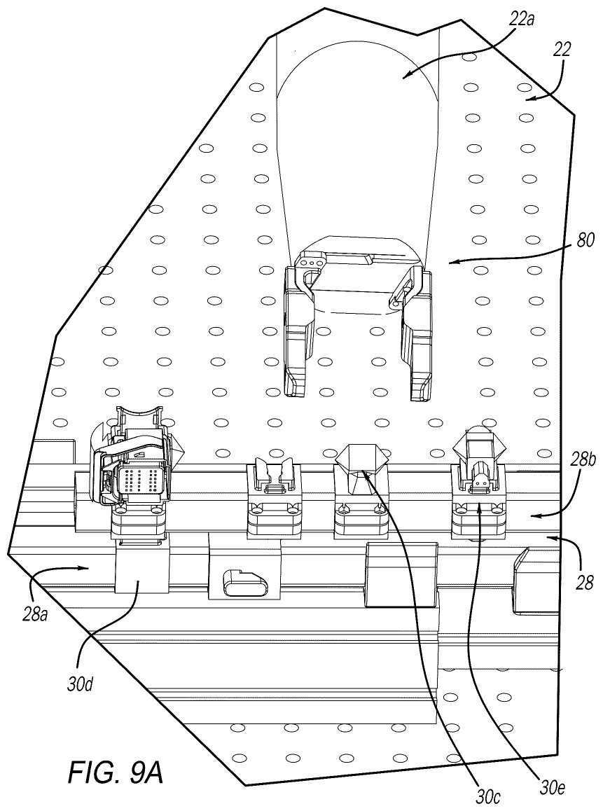

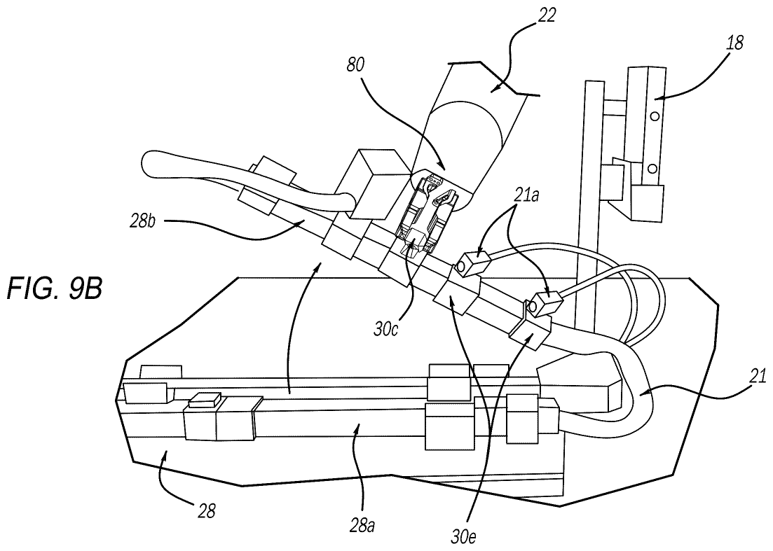

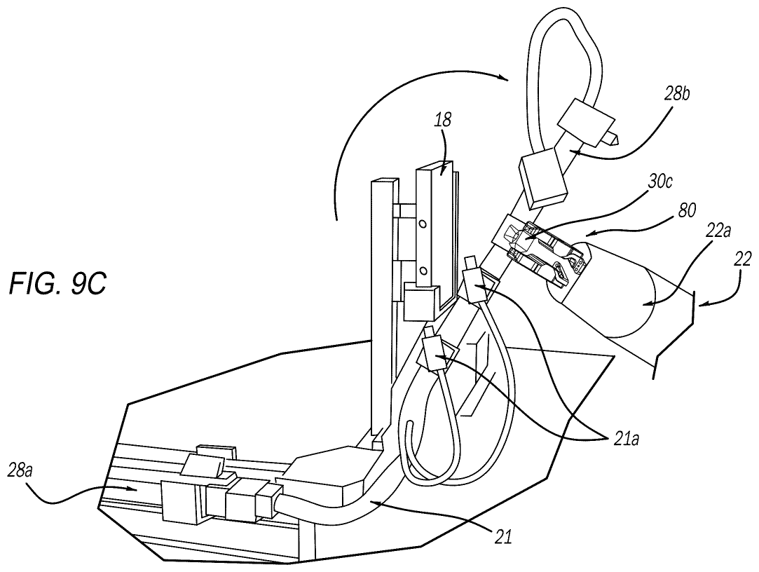

At 208, the control algorithm, using the controller 26, instructs the robot 22 to move the section 28b of the body 28 relative to the section 28a of the body 28 to another location of the fixture 14 (FIGS. 9A-9C). In moving the section 28b to another location of the fixture 14, the retention features 76 of the collars 30e are removed from the retention sockets 52 of the collars 30d, thereby detaching the section 28b of the body 28 from the section 28a of the body 28. The electrical connectors 21a remain coupled to the collars 30e (and the section 28b) as the section 28b is moved to another location of the fixture 14.

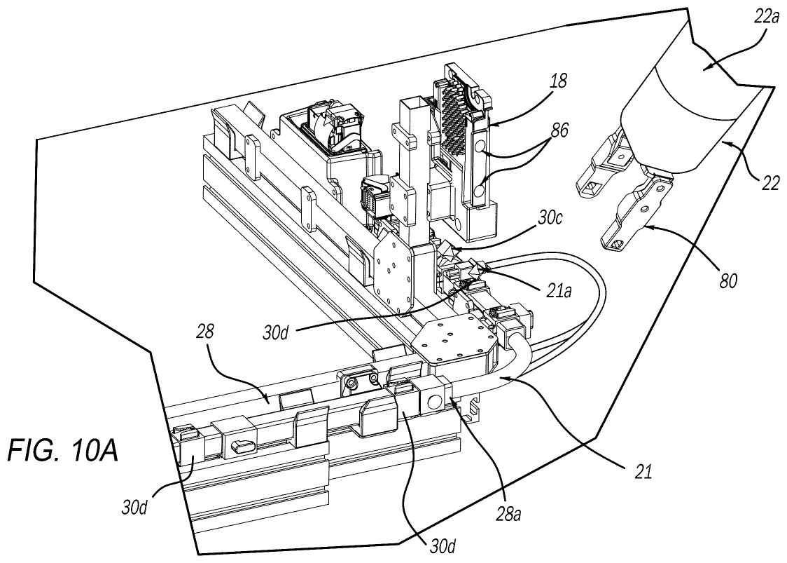

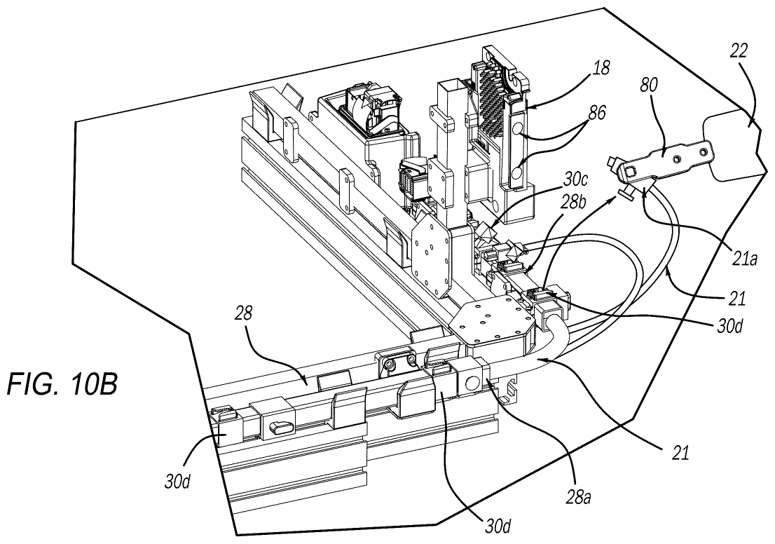

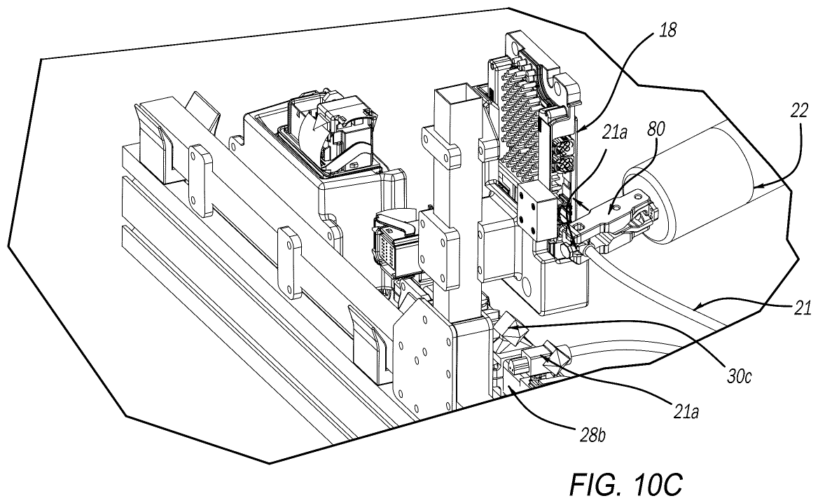

At 212, the control algorithm, using the controller 26, instructs the robot 22 to move the pair of grippers 90 from the closed position to the open position. At 216, the control algorithm, using the controller 26, instructs the robot 22 to align the pair of grippers 90 with the retention features 87a, 87b of a respective electrical connector 21a and move the pair of grippers 90 from the open position to the closed position. In this way, the robot 22 grasps the respective electrical connector 21a (FIG. 10B). At 220, the control algorithm, using the controller 26, instructs the robot 22 to move each electrical connector 21a to a respective vehicle module 18 and connect the electrical connector 21a to the terminal 86 of the respective vehicle module 18 (FIG. 10C). In moving the electrical connector 21a to the respective vehicle module 18, the first retention feature 85b of the electrical connector 21a is removed from the retention sockets 74 of the collars 30e, thereby detaching the electrical connector 21a from the section 28b of the body 28.

Once all the electrical connectors 21a have been connected to the respective vehicle modules 18, another robot (not shown) grabs the fixture 14 including the vehicle component 12 and moves it to the machine where the vehicle component 12 and the vehicle modules 18 are secured to the machine. The robot 22 may move back to the starting position where it may attach to another collar 30c of another vehicle component 12, thereby repeating the process again. It should be understood that, in some configurations, the grippers 90 may include the retention features and the collars 30c and the electrical connectors 21a may include the mounting features without departing from the scope of the present disclosure.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A system for handling electrical components of a vehicle, the system comprising:
a workpiece configured to include a set of the electrical components, the workpiece including a pair of opposed first retention features, each first retention feature of the pair of opposed first retention features includes a first proximal end, a first distal end, and an outer periphery tapered from the first proximal end towards the first distal end; and
a robotic gripper apparatus comprising:
a pair of opposed grippers moveable between a first position in which the pair of opposed grippers engage the pair of opposed first retention features and a second position in which the pair of opposed grippers are disengaged from the pair of opposed first retention features, each gripper includes a mounting feature having a second proximal end, a second distal end, and an inner periphery, the second proximal end opens through an inner side of the gripper, the inner periphery is tapered from the second proximal end towards the second distal end,
wherein when the pair of opposed grippers are in the first position, a first portion of the inner periphery near or at the first proximal end engages a first portion of the outer periphery near or at the second proximal end and a second portion of the inner periphery near or at the first distal end is separated from a second portion of the outer periphery near or at the second distal end.

2. The system of claim 1, wherein:
the outer periphery of each first retention includes a pair of opposed surfaces extending at a first angle relative to each other; and
the inner periphery of each mounting feature includes a pair of opposed surfaces extending at a second angle relative to each other, the first angle different from the second angle.

3. The system of claim 2, wherein the first angle is greater than the second angle.

4. The system of claim 1, wherein the mounting feature of each gripper is an aperture extending through the gripper.

5. The system of claim 4, wherein when the pair of opposed grippers are in the first position, the second portion of the inner periphery of each mounting feature extends through the mounting feature.

6. The system of claim 1, wherein each first retention feature of the pair of opposed first retention features has a pyramid shape.

7. The system of claim 1, wherein the workpiece further includes a body configured to house the set of electrical components, and wherein the pair of opposed first retention features are spaced apart from the body.

8. The system of claim 1, wherein the workpiece further includes a pair of opposed second retention features.

9. The system of claim 1, further comprising:
a body configured to house the set of electrical components, the body including a retention socket defining a cavity and an opening in communication with the cavity;
the workpiece further includes a second retention feature including a neck region and a tab extending from the neck region.

10. The system of claim 9, wherein the tab has a polygonal shape.

11. The system of claim 9, further comprising:
a controller configured to move the pair of grippers between the first position and the second position,
wherein when the pair of grippers are in the first position, the controller is configured to instruct the robotic gripper apparatus to move the workpiece between a locked position in which the tab is received in the cavity and the neck region is received in the opening, and an unlocked position in which the tab is removed from the cavity and the neck region is removed from the opening.

12. The system of claim 11, wherein the tab includes a pair of opposed flat sides that engage with and correspond to a pair of opposed sides defining the cavity to inhibit rotation of the workpiece when in the locked position.

13. A system for handling electrical components of a vehicle, the system comprising:
a workpiece configured to include a set of the electrical components, the workpiece including a pair of opposed first retention features, each first retention feature of the pair of opposed first retention features includes a first proximal end, a first distal end, and an outer periphery tapered from the first proximal end towards the first distal end, the outer periphery includes a pair of opposed surfaces extending at a first angle relative to each other;
a robotic gripper apparatus comprising:
a pair of opposed grippers moveable between a first position in which the pair of opposed grippers engage the pair of opposed first retention features and a second position in which the pair of opposed grippers are disengaged from the pair of opposed first retention features, each gripper includes a mounting feature having a second proximal end, a second distal end, and an inner periphery, the second proximal end opens through an inner side of the gripper, the inner periphery is tapered from the second proximal end towards the second distal end and including a pair of opposed surfaces extending at a second angle relative to each other, the second angle different from the first angle; and
a controller configured to move the pair of grippers between the first position and the second position;
wherein when the pair of opposed grippers are in the first position, a first portion of the inner periphery near or at the first proximal end engages a first portion of the outer periphery near or at the second proximal end and a second portion of the inner periphery near or at the first distal end is separated from a second portion of the outer periphery near or at the second distal end.

14. The system of claim 13, wherein the first angle is greater than the second angle.

15. The system of claim 13, wherein each first retention feature of the pair of opposed first retention features has a pyramid shape.

16. The system of claim 13, wherein the mounting feature of each gripper is an aperture extending through the gripper.

17. The system of claim 13, further comprising:
a body configured to house the set of electrical components, the body including a retention socket defining a cavity and an opening in communication with the cavity; and
the workpiece further includes a second retention feature including a neck region and a tab extending from the neck region.

18. The system of claim 17, wherein when the pair of grippers are in the first position, the controller is configured to instruct the robotic gripper apparatus to move the workpiece between a locked position in which the tab is received in the cavity and the neck region is received in the opening, and an unlocked position in which the tab is removed from the cavity and the neck region is removed from the opening.

19. The system of claim 18, wherein the tab includes a pair of opposed flat sides that engage with and correspond to a pair of opposed sides defining the cavity to inhibit rotation of the workpiece when in the locked position.

20. A system for handling electrical components of a vehicle, the system comprising:
a wire harness body configured to house a first set of electrical components, the wire harness body including:
a pair of opposed first protrusions, each first protrusion of the pair of opposed first protrusions includes a first proximal end, a first distal end, and a first outer periphery tapered from the first proximal end towards the first distal end, and
a retention socket defining a cavity and an opening in communication with the cavity;
a workpiece configured to include a second set of the electrical components, the workpiece including:
a pair of opposed second protrusions, each second protrusion of the pair of opposed second protrusions includes a second proximal end, a second distal end, and a second outer periphery tapered from the second proximal end towards the second distal end, and
a retention feature including a neck region and a tab extending from the neck region;
a robotic gripper apparatus comprising:
a pair of opposed grippers moveable between a first position in which the pair of opposed grippers engage the pair of opposed first protrusions of the wire harness body and a second position in which the pair of opposed grippers engage the pair of opposed second protrusions of the workpiece, each gripper includes a mounting feature having a third proximal end, a third distal end, and an inner periphery, the third proximal end opens through an inner side of the gripper, the inner periphery is tapered from the third proximal end towards the third distal end; and
a controller configured to move the pair of grippers between the first position and the second position;
wherein when the pair of opposed grippers are in the first position, a first portion of the inner periphery near or at the third proximal end engages a first portion of the first outer periphery near or at the first proximal end and a second portion of the inner periphery near or at the third distal end is separated from a second portion of the first outer periphery near or at the first distal end,
wherein when the pair of opposed grippers are in the second position, the first portion of the inner periphery near or at the third proximal end engages a first portion of the second outer periphery near or at the second proximal end and the second portion of the inner periphery near or at the third distal end is separated from a second portion of the second outer periphery near or at the second distal end, and
wherein when the pair of grippers are in the second position, the controller is configured to instruct the robotic gripper apparatus to move the workpiece between a locked position in which the tab is received in the cavity and the neck region is received in the opening, and an unlocked position in which the tab is removed from the cavity and the neck region is removed from the opening.
